(19) United States
(12) Patent Application Publication
(10) Pub. No.: US 2023/0030687 A1
(43) Pub. Date: Feb. 2, 2023

(54) Pet Grooming Tool

(71) Applicant: AARONCO PET PRODUCTS, INC., Somers, NY (US)

(72) Inventor: Samuel Kohl, Somers, NY (US)

(21) Appl. No.: 17/388,636

(22) Filed: Jul. 29, 2021

(51) Int. Cl. A01K 13/00; A46B 9/02; A46D 1/00; A45D 24/30

(52) U.S. Cl. CPC A01K 13/002; A46B 9/026; A46D 1/0207; A45D 24/30; A46B 2200/1093

(57) ABSTRACT

A grooming tool for removing fleas from the coat of an animal such as a dog, has an arc of pins, and a handle on which the arc of pins is mounted.

### BACKGROUND OF THE INVENTION

The present invention is directed to a grooming tool for removing pests such as fleas from the coat of animals, e.g., pets such as dogs, cats, horses, rabbits, ferrets. More particularly, the present invention comprehensively improves removal of such fleas in efficient manner, with minimal trauma to the animal.

Various grooming tools for removing pests such as fleas are well-known, all of which having straight rows of pins or tines for grabbing and picking the fleas off the coat of the animal. It was previously-thought all such flea-removal grooming tools needed to be tiny and straight, i.e., resembling a fine comb, to effectively grab and remove fleas and ticks from the coat of hair of an animal.

However, animals such as dogs do not possess straight bodies as a line of pins, but rather naturally possess round or curved contours with various protrusions and indentations following the body curve. Therefore, it has now been found arranging the pins or tines along a curved arc actually improves more easily removing pests such as fleas and ticks, because the curved arc of pins more precisely follows the contours of the animals, at the same time reducing potential irritation of the animal's skin and potential trauma to the animal.

Curving the end of the grooming tool supporting a curved row of pins or tines, improves removal of fleas and ticks, by covering more surface at different angles as the coat of the animal is combed. This reduces the number of times the coat of the animal must be combed, because greater numbers of fleas are removed in a single combing stroke with this grooming tool. At the same time, the improved efficiency of the grooming tool allows size and weight to be reduced, improving handling along with reducing material such as plastic required to manufacture the grooming tool.

Accordingly, it is an object of the present invention to improve grooming of an animal such as dog, notably removing pests such as fleas from the coat of the animal.

It is a more specific object of the present invention to improve efficiency of removing pests and fleas from coats of animals, by reducing number of combing strokes required to remove such fleas.

It is also an object of the present invention to reduce irritation and potential trauma to the animal while grooming.

It is another object of the present invention to improve handling of a grooming tool for removing, e.g., fleas and ticks, from the coat of an animal, especially improving comfort for the groomer's hands while using the tool.

It is a further object of the present invention to improve handling of a grooming tool such as a flea remover, by reducing weight of the tool, while conserving raw material in manufacture thereof.

### SUMMARY OF THE INVENTION

These and other objects are attained by the present invention which is directed to a grooming tool especially designed for removing pests such as fleas or ticks from the coat of an animal such as a dog, and having an arc of pins, and a handle on which the arc of pins is mounted, in turn having a curved end on which the arc of pins is mounted, and a stem centrally extending from the curved end. A through-hole extends through the stem at an end opposite the curved end on which the pins are mounted, e.g., to allow the tool to be hung on a hook when not used. A slot longitudinally extends through the stem between the through-hole and the curved end of the handle, for decreasing weight of the tool and conserving plastic in molding of the tool. In this regard, the curved end of the plastic has a series of blind bores for receiving the respective pins which are either force-fit thereinto after molding or situated in a mold when molding the handle.

The grooming tool according to the present invention improves flea and pest removal from the coat of an animal by the curved arrangement of pins or tines sweeping across and following the curved contours of an animal during combing. Therefore, this grooming tool can be made larger than conventional grooming tools for this purpose and is therefore much easier to handle by a groomer, not only reducing potential irritation to the groomed animal, but also comfort for the groomer's hands.

### BRIEF DESCRIPTION OF THE DRAWINGS

The present invention will be described in greater detail with reference to the accompanying drawings in which

FIG. 1 illustrates a top perspective view of the grooming tool according to the present invention,

FIG. 2 illustrates a top plan view of the grooming tool according to the present invention, and

FIG. 3 illustrates a bottom plan view of the grooming tool according to the present invention.

### DESCRIPTION OF THE PREFERRED EMBODIMENTS

As illustrated in the drawings, the grooming tool 1 is especially designed for removing fleas from the coat of an animal such as a dog, and has an arc of a series pins 2, and a handle 3 on which the arc of pins 2 is mounted, in turn having a curved end 4 on which the arc of pins 2 is mounted, and a stem 5 centrally extending from the curved end 4. A through-hole 6 extends through the stem 5 at an end opposite the curved end 4 on which the pins 2 are mounted, e.g., to allow the tool 1 to be hung on a hook when not used. A slot 7 longitudinally extends through the stem 5 between the through-hole 6 and the curved end 4 of the handle 3, for decreasing weight of the tool 1 and conserving plastic during molding of the tool 1. In this regard, the curved end 4 of the plastic has a series of blind bores for receiving the respective pins 2 which are either force-fit thereinto after molding or molded therearound when forming the tool 1.

The pins 2 themselves are formed of suitable metal, e.g., stainless steel. The handle 5 of the tool 1 may be molded from suitable hard plastic, e.g., polycarbonate, polyesters, polysulfone, polyamide, polyimide, polyetherimide, polyether ether ketones, polystyrene, polyphenylene oxide, polyphenylene sulfide, polylactide, polyolefin such as polyethylene, polypropylene, thermoplastic elastomers such as but not limited to styrene-ethylene-butylene-styrene copolymer, acrylics, acrylonitrile butadiene styrene copolymer, acetal, polyimidazole and polyvinyl chloride. Preferably, the material used to form the handle 5 should be non-toxic.

Adjacent pins 2 are minutely spaced from one another. This arrangement of pins 2 along an arc at the end 4 of the handle 3, especially facilitates removal of fleas, ticks and other pests from the coat of an animal such as a dog, cat, horse, rabbit, ferret, etc., by allowing the tool 1 to precisely follow along the curved or rounded contours of the animal when grooming.

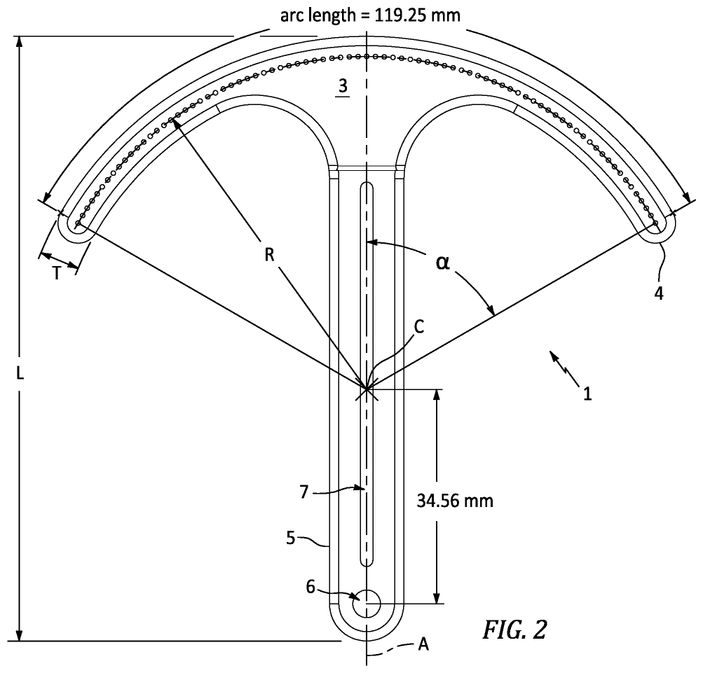

In particular, a radius of curvature R of the arc of pins 2 as measured from the center C of an imaginary circle on the stem 5 of the handle 3, is approximately 50 to about 60 mm., preferably approximately 53-54 mm., and most preferably about 53.69 mm. as denoted in FIG. 2. The angle α between the last pin 2 in the curved series of pins forming the arc 4, and a longitudinally-extending axis A of the stem 5, is approximately 60°, so the total sweep of the arc 4 of pins 2 is approximately ⅓ of a circle. Alternatively, the arc of pins 2 can be curved to form part of an imaginary ellipse, and need not form a segment of a circle.

In a preferred embodiment, from about 75 to about 90 pins 2 are mounted around the arc, preferably about 81 pins 2. In particular, the arc measured along the outermost surface of the curved end 4 on which the pins 2 are mounted is approximately 115 to about 125 mm., more preferably about 119-120 mm., and most preferably about 119.25 mm. as indicated on FIG. 2.

The stem 5 is approximately 30 to about 35 mm. in length between the center of the through-hole 6 and center C of the imaginary circle, preferably about 34-35 mm., and most preferably about 34.56 mm. Additionally, the thickness T of the curved end 4 of the handle 3 is approximate 5 to 12 mm., more preferably about 9-10 mm. and most preferably about 9.75 mm. as shown in FIG. 2, while the pins 2 are approximately 12-13 mm. in height when protruding from the curved end 4 of the handle 3, most preferably about 12.7 mm. in height.

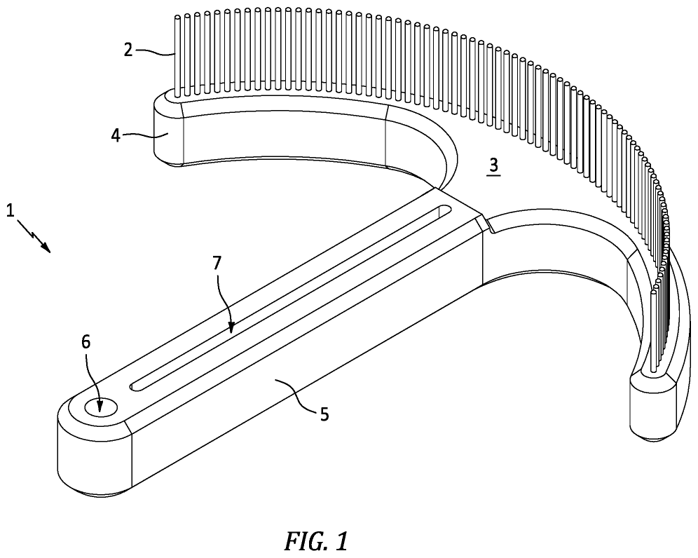

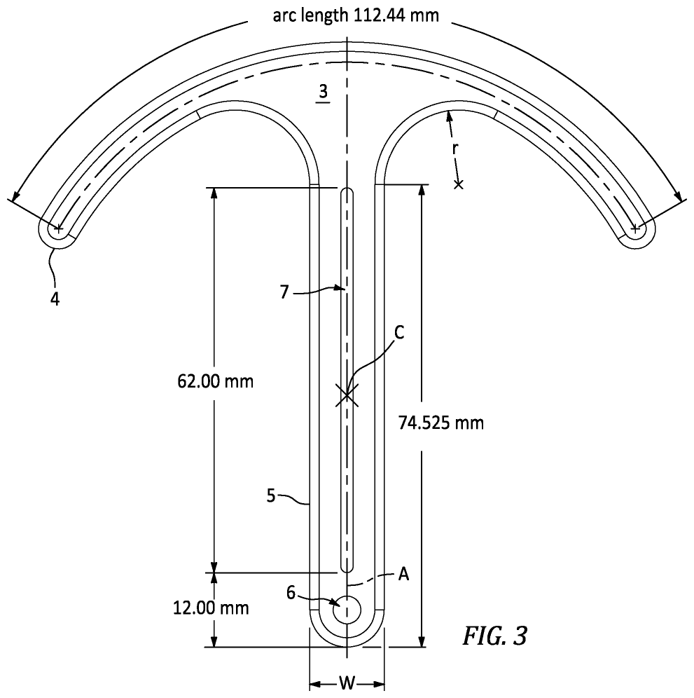

Furthermore, as shown, e.g., in FIG. 2, the maximum length L of the tool 1 end-to-end is approximately 110-115 mm., preferably about 113-114 mm. and most preferably about 113.88 mm. As shown in FIGS. 1-3, the areas where the stem 5 of handle 3 meets the curved end 4 is also curved on either side of the stem 5, with the radius of curvature r being approximately 10-15 mm., preferably about 12 mm. as shown in FIG. 3. The arc length between the first and last pins 2 themselves in the row in FIG. 3 (as opposed to the external arc length shown in FIG. 2 supra) is approximately 110-115 mm., more preferably about 112-113 mm., and most preferably about 112.44 mm.

Additionally, as shown in FIG. 3, the width W of the stem 5 is approximately 10-15 mm., preferably about 12 mm., longitudinal length of the slot 7 is approximately 60-65 mm., preferably about 62 mm. end-to-end, with the length of the stem 5 between the end at the through-hole 6 and the slot being approximately 10-15 mm., preferably about 12 mm., and the total length of the straight portion of the stem 5 at the end at the through-hole 6 to the curved areas of the handle 3 on either side of the stem 5, being approximately 74-75 mm., preferably about 74.525 mm.

All these dimensions facilitate design of the grooming tool 1 to improve grooming of an animal, especially removal of pests such as fleas and ticks. For example, the combination of the arc of pins joining the straight handle stem in a curved arch as shown, especially enhances ability to control the tool and groom the animal to remove fleas and ticks.

The preceding description of the invention is merely exemplary and not intended to limit the scope thereof in any way.

What is claimed is:

1. A grooming tool for removing fleas from the coat of an animal such as a dog, comprising
an arc of pins, and
a handle on which the arc of pins is mounted.

2. The tool of claim 1, wherein the handle comprises
a curved end on which the arc of pins is mounted, and
a stem centrally extending from the curved end.

3. The tool of claim 1, wherein a radius of curvature of the arc of pins is approximately 50 to 60 mm.

4. The tool of claim 3, wherein the radius of curvature is approximately 53-54 mm.

5. The tool of claim 2, wherein the curved end of the handle forms a segment of a circle.

6. The tool of claim 5, wherein the curved end of the handle forms an approximately 120° segment of a circle.

7. The tool of claim 6, wherein the stem bisects the segment into approximately 60° arcs.

8. The tool of claim 6, comprising from about 75 to about 90 pins mounted upon said segment.

9. The tool of claim 8, comprising approximately 81 pins mounted upon said segment.

10. The tool of claim 2, wherein the stem comprises a through-hole at an end opposite the curved end on which the pins are mounted.

11. The tool of claim 10, wherein the stem additionally comprises a longitudinally-extending slot separated from the through-hole and situated between the through-hole and the curved end.

12. The tool of claim 1, wherein the pins are made of metal and the handle is made of plastic.

13. The tool of claim 12, wherein the handle is made of hard plastic.

14. The tool of claim 2, wherein a location of the handle where the curved end meets the stem is also curved on either side of the stem.

15. The tool of claim 1, wherein adjacent pins are minutely spaced one another.

16. The tool of claim 5, wherein a center of an imaginary circle of which the arc of pins forms a circumference, falls on a longitudinally-extending axis of the stem.
